(19) United States
(12) Patent Application Publication
(10) Pub. No.: US 2014/0304281 A1
(43) Pub. Date: Oct. 9, 2014

(54) METHOD AND SYSTEM FOR GRAPHICAL DATA ANALYSIS

(71) Applicant: BENJAMIN RIGLER HALPERN, SANTA CRUZ, CA (US)

(72) Inventor: BENJAMIN RIGLER HALPERN, SANTA CRUZ, CA (US)

(21) Appl. No.: 14/246,517

(22) Filed: Apr. 7, 2014

Related U.S. Application Data
(60) Provisional application No. 61/853,565, filed on Apr. 8, 2013.

(51) Int. Cl. G06F 17/30

(52) U.S. Cl. CPC G06F 17/30867; G06F 17/30498
USPC 707/754; 707/756

(57) ABSTRACT

A computer implemented method and system for interacting with and performing detailed analysis of digital databases. A user may perform analysis on a database by interacting entirely with graphical representations of the data within that database. The system may generate various types of charts to display summaries of all data available for analysis, and then allow a user to graphically partition this data into various disjoint groups to perform separate analysis on. Data records may be moved between these groups freely, and types of analysis performed on each group may be customized by the user. Any steps taken in either partitioning the data records or analyzing the groups will be recorded, and may be applied to other databases at a later time, allowing the user to establish preferred analytic method routines.

### CO-PENDING US PROVISIONAL PATENT APPLICATION

The present Nonprovisional Patent Application is a Continuation-in-Part Patent Application of U.S. Provisional Patent Application Ser. No. 61/853,565, filed on Apr. 8, 2013. The present Nonprovisional Patent Application claims the priority date of Provisional Patent Application Ser. No. 61/853,565. Furthermore, Provisional Patent Application Ser. No. 61/853,565 is hereby incorporated into the present Nonprovisional Patent Application in its entirety and for all purposes.

### FIELD OF THE INVENTION

The present invention relates to data analysis by means of a graphical user interface. More particularly, the present invention relates to methods of, and systems for, enabling user interaction with, and detailed analysis of, a database by means of a graphical user interface.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art enables parties to perform analysis on digital databases, and generate multiple kinds of graphical representations of data via various mathematical and computational tools, such as the statistical analysis tools provided in or via EXCEL™ statistical analytics software products marketed by Microsoft, Inc. of Redding, Wash.; SPSS™ statistical analytics software products marketed by IBM of Armonk, N.Y.; SAS/STAT™ statistical analytics software marketed by SAS, Inc. of Cary, N.C.; and/or TABLEAU DESKTOP™ statistical analytics software, TABLEAU ONLINE™ statistical analytics software offered as a service and TABLEAU SERVER™ statistical analytics software marketed by Tableau Software of Seattle, Wash.

Yet the prior art fails to enable manipulation and accurate analysis of digital databases in a purely graphical method.

There is therefore a long-felt need to enable a user to approach analysis of digital databases by entirely graphical means, to more effectively perform required analysis.

### SUMMARY AND OBJECTS OF THE INVENTION

Towards the object of enabling interaction with and analysis of digital databases via an entirely graphical user interface, and other objects made obvious in light of the present disclosure, a system and method are provided that enable a computer implemented method for visualizing data stored in a database in the form of graphical charts.

The method of the present invention (hereinafter, “the invented method”) enables, in certain alternate preferred embodiments, the aspects of rendering on a display screen one or more of a bar chart, a scatter plot, a line chart, pie chart and/or other suitable charts known in the art, a primary display band, and allowing user interaction to selectively partition data records into any number of secondary bands while generally avoiding verbal inputs to a rendering system. The invented method further enables the user directing the rendering system to perform further analysis on data records contained in any band or selection of bands to generate content-selected partitioned images.

In addition the present invention provides a system and a computer implemented method of performing a join operation of tables of one or more relational databases wherein duplicated field keys are systematically renamed to prevent the loss of any fields in the resulting join operation results. Certain alternate optional aspects of the invented method include (a.) accessing a first table having a primary key, (b.) accessing a second table having a first foreign key and a second foreign key, wherein both foreign keys point to the primary key of the first table, (c.) duplicating the first table by generating at least some of the data of the first table to a duplicated table and renaming all data fields of the duplicated table to alternate names that are unique and distinguishable data field names within the database(s); (d.) renaming the first foreign key of the second table to match the primary key of the first table; (e.) renaming the second foreign key of the second table to match a renamed primary key of the duplicated first table, i.e., a third table. (f.) and finally executing a natural join applying the renamed first foreign key of the second table to the first table and the renamed second foreign key of the second table to the renamed primary key of the duplicated third table.

Immediate potential applications of the invented method include uses in business intelligence, online shopping and general e-commerce, analysis of sports data, medical research and patient care, horse racing, admissions processes in academic institutions, scientific research, and analysis of financial markets.

In addition to aiding business intelligence non-verbally the invented method optionally or additionally features partitioning of the data. Partitioning data is a process that subsumes filtering and adds the advantage of retaining all the data and facilitating un-partitioning wherein data once removed from one subset is added back to that subset. That is, the present invention supports a fully reversible method of partitioning data as opposed to filtering data. In contrast, filtering data typically impedes or disables access to data that has been previously filtered out from a set of data, and thereby denies or creates barriers to a user viewing or accessing such filtered out data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 illustrates a computer system that facilitates visual analysis of a database in accordance with one embodiment of the present invention.

FIG. 2 is a summary of visual elements a user may interact with in one embodiment of the invented method.

FIG. 3 is a flow chart depicting a possible use of the present invention.

FIG. 4 is a flow chart depicting a possible use of the present invention to perform a natural join between two tables of a relational database.

FIG. 5 is a flow chart depicting possible steps in saving some or all of the analysis steps and or display settings created by a user in one embodiment of the present invention.

FIG. 6 is a flow chart depicting a use of the present invention in applying previously saved analysis steps and or display settings to a presently open database.

FIG. 7 is a flow chart depicting a use of the present invention where the data source used for analysis is updated either by the user or automatically and all charts are updated by the system to reflect all changes made to the data source.

FIG. 8 is a flow chart depicting a use of the present invention to access and analyze data from one or more ecommerce data sources, and transmit both a purchase choice and purchase authorization.

FIG. 9 is a network diagram illustrating the computer of FIG. 1 in bi-directional communicative coupling with an electronics communications network that includes ecommerce webservers.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

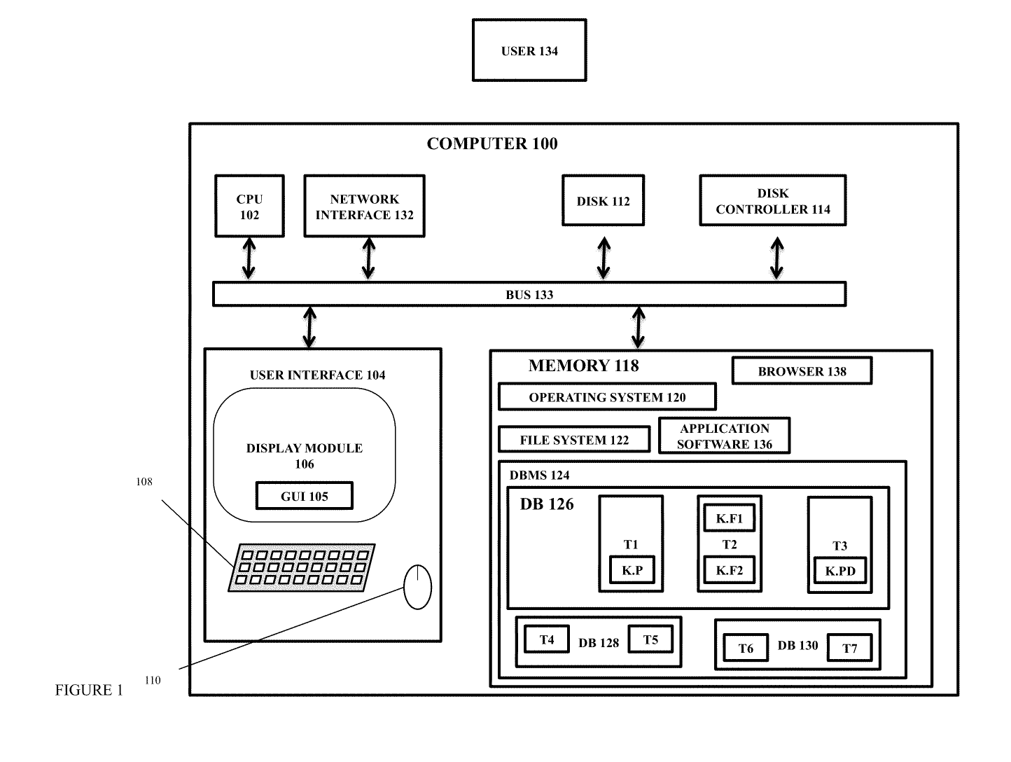

Referring now generally to the Figures and particularly to FIG. 1, FIG. 1 illustrates a computer 100 that facilitates visual analysis of a database 126-130 in accordance with one embodiment of invented method. The computer 100 may be the information technology system 200 may be or comprise (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) a TOUGHPAD™ tablet computer as marketed by Panasonic Corporation of Kadoma, Osaka, Japan and running an ANDROID™ operating system as marketed by Google, Inc. of Mountain View, Calif.; (h.) an IPHONE™ digital cellular telephone marketed by Apple, Inc. of Cupertino, Calif. or (h.) other suitable smart phone, tablet computer, computational system, and/or electronic communications device known in the art known in the art.

Computer 100 comprises a central processing unit 102 and a user interface 104. The user interface consists of a graphical user interface 105 presented in a video graphical display device 106, which may or may not be a touch screen display, and one or more input devices such as a keyboard 108 or mouse 110. The computer 100 further comprises main storage disk 112 for storing system software and data, and a disk controller 114 which controls main storage disk 112, a system memory 118, most commonly random-access memory (RAM) for temporarily storing system controls and application data loaded from main storage disk 112 and an optional network interface 132 that enables the computer 100 to bi-directionally communicate with one or more wired or wireless communication networks and/or the World Wide Web. An internal communications bus 133 bi-directionally communicatively couples the central processing unit 102 with the user interface 104, the system memory 118, the network interface 132 and the disk controller 114.

The computer 100 is generally controlled by an operating system 120 which is executed by the central processing unit 102 in accordance with input from a user 134, in addition to the operating system 120, a file system 122 and database management system 124 (hereinafter “DBMS” 124) containing one or more databases 126-130 are stored on the main storage disk. More generally, database 126 is any form of data storage system, including but not limited to a flat file, a relational database. The database management system software 124 may be a custom database management system or a commercially available database management system software, whereby the database management system software 124, (hereinafter, “DBMS” 124) such as an object oriented database system provided by Objectivity, Inc. of Mountain View, Calif. or an SQL-compliant database software management system as provided by IBM of Armonk, N.Y.

The file system 122 allows for the storage and retrieval of files that may be used in an application of the present invention, while the DBMS 124 allows the computer 100 to access databases 126-130 for use in accordance with one embodiment of invented method.

An application software 136 preferably stored within the computer 100 enables and directs the computer 100 to interact with the user 134 and to perform one, more or all aspects of the invented method disclosed in the present disclosure. A web browser software 138 enables the computer 100 to harvest information from the World Wide Web via the network interface 132. The web browser 138 may be or comprise a SAFARI™ web browser software marketed by Apple, Inc. of Cupertino, Calif., a CHROME™ web browser software marketed by Google, Inc. of Mountain View, Calif., and or other suitable web browser software known in the art.

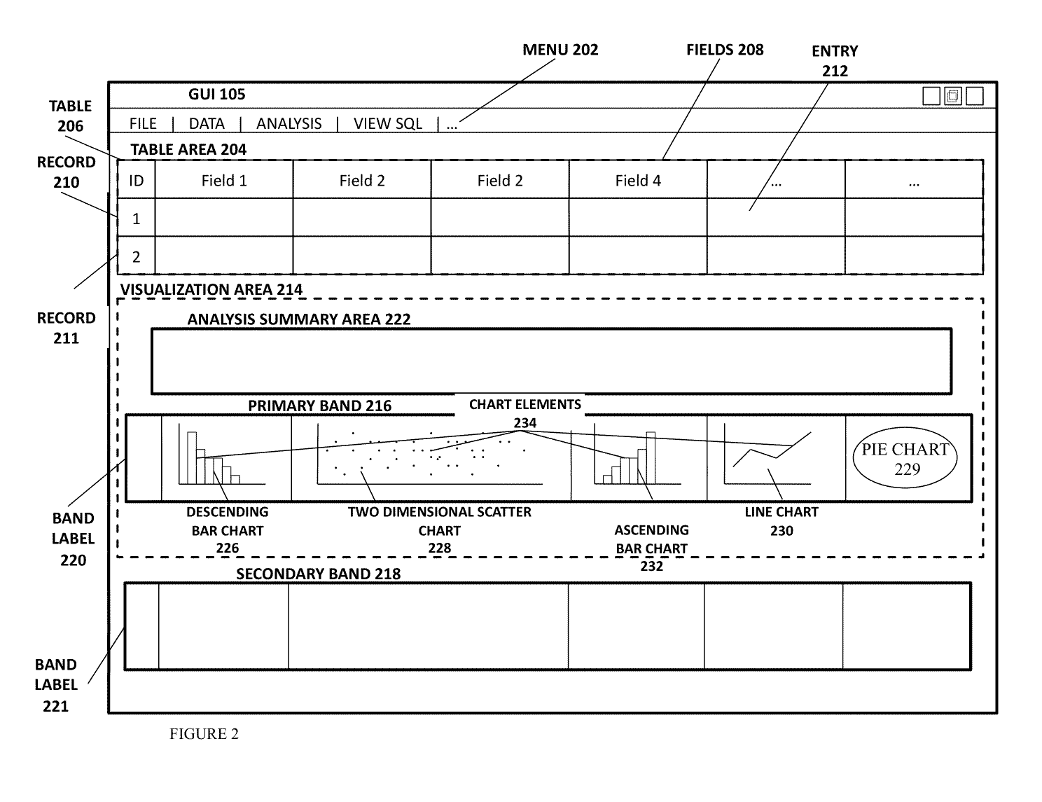

Referring now generally to the Figures and particularly to FIG. 2, FIG. 2 is a summary of visual elements a user 134 may interact with in various alternate preferred embodiments of the invented method. The user 134 interacts with the computer 100 including elements of the display 106, that consist of at least a menu 202 which allows the user 134 to direct the application software 136 to direct the computer 100 to perform various desired tasks, such as accessing a relational database table T1-T7 of a relational database 126-130, performing operations on the data of one or more relational data base tables T1-T7 (hereinafter “tables” T1-T7), and performing analysis on data rendered within one, more than one or all of selected bands 216-218. Outside the menu 202 are two main areas, the table area 204 which contains a grid display of a representative table 206 of the tables T1-T7 of entries 212 arranged into fields 208 and a plurality of records 210 & 211, and a visualization area 214. The visualization area 214 contains a primary band 216, optionally indicated by an optional first band label 220, wherein initial charts 226-232 summarizing the data are displayed, these charts may consist of one or more of a descending bar chart 226, a two dimensional scatter chart 228, a line chart 230, and or an ascending bar chart 232, one or more secondary bands 218 each optionally having a unique secondary band label 221 where charts 226-232 summarizing partitioned data are displayed, and one or more analysis summary areas 222 wherein results of analysis performed on one or more bands 216-218 are displayed.

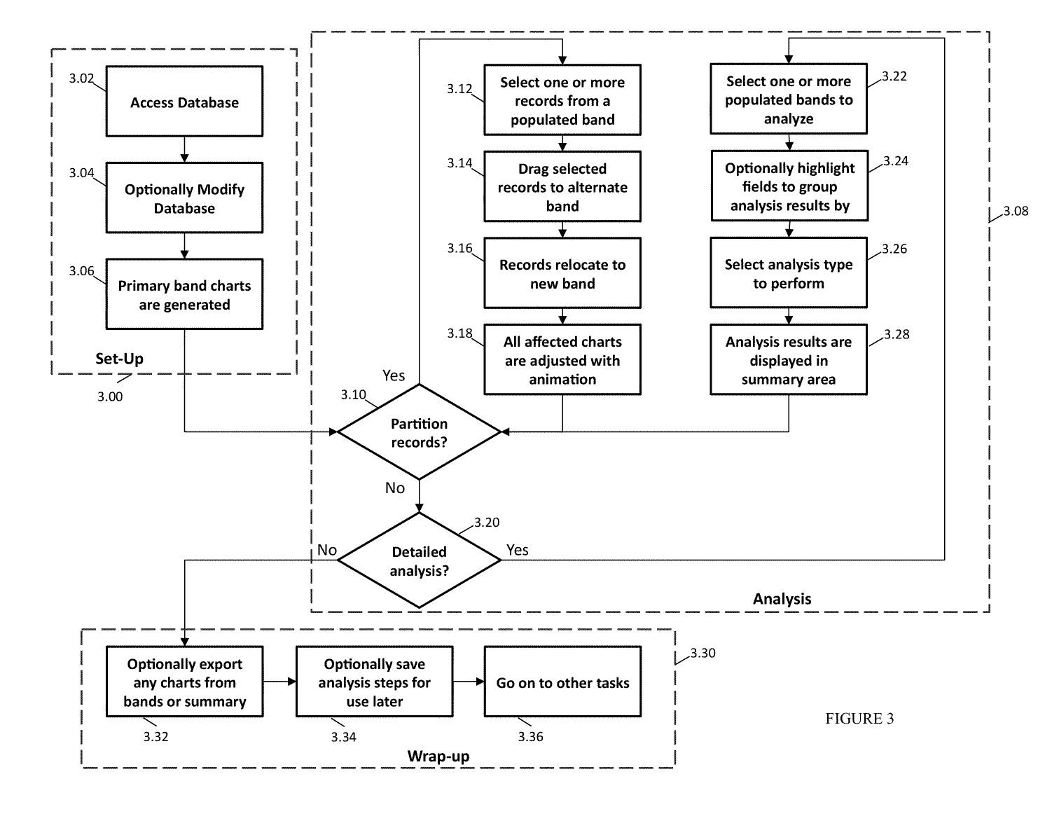

Referring now generally to the Figures and particularly to FIG. 3, FIG. 3 is a flow chart depicting a possible use of invented method. In the first stage 3.00 and specifically in step 3.02 the user 134 directs the computer 100 to access a database 126 that is to be analyzed. In step 3.04 user 134 is optionally able to modify the entries 212 or structure of the data by clicking on elements of the displayed table 206, examples of such modifications may include changing values in a specific entry 212 or changing the order of fields 208 by selecting and dragging any field 208 to a new location within the table 206. In step 3.06 the computer 100 populates the primary band 216 with charts 226-232 that graphically display summary information of the data, charts 226-232 are aligned to be shown directly below the table field 208 that contains the data being summarize, if the user 134 indicates that a chart 226-232 should display summary information from more than one adjacent field 208 simultaneously, such as in a two dimensional scatter chart 228, then the chart 226-232 is aligned with all fields 208 that contain the data being summarized.

In the next stage 3.08 the user 134 may perform analysis. In step 3.10 the user 134 may choose to partition the data. If the user 134 chooses to do so, in step 3.12 the user 134 will begin by selecting one or more records 210 to be partitioned out of the primary band 216 and into a secondary band 218. The user 134 may select records 210 by clicking directly on any chart elements 234 that contain records 210, by drawing a marquee box around any chart elements 234, or any combination of these methods. Records 210 may be added or removed from a present selection through a combination of keyboard 108 key strokes and mouse 110 clicks. Once the user 134 has selected the desired records 210, the user 134 may drag the selection to any secondary band 218 in step 3.14, upon release of the mouse 110 button all selected records 210 will be relocated by the computer 100 to the terminal band in step 3.16. In step 3.18 the computer 100 will update all affected charts 226-232 by animating all changes that need to be made. The charts 226-232 that are created by the computer 100 in any secondary bands 218 are aligned in the same way that charts 226-232 are aligned in the primary band 216, specifically to be displayed in alignment with fields 208 that contain the data being summarized.

Now returning to step 3.10 the user 134 may decide if further partitioning of the data is desired, if so the user 134 continues to step 3.12 and repeats the appropriate steps. Records 210 may be partitioned both out of and into any band 216-218, any partition is fully reversible. If no more partitioning is desired, the user 134 moves on to step 3.20.

In step 3.20 the user 134 is able to decide, and direct the computer 100 accordingly, if any analysis will be performed on the partitioned data. If so, in step 3.22 the user 134 selects one or more bands (primary 216 and/or secondary 218) on which the analysis is to be performed and/or analytic results are to be rendered.

In step 3.24 the user 134 may optionally indicate, by clicking on any chart 226-232, a field 208 or fields 208 by which to group analysis results. In step 3.26, the user 134 indicates to the computer 100 what analysis is to be performed by making a selection from the analysis section of the menu 202.

In step 3.28 the computer 100 performs selected analysis and displays the results grouped by the specified fields 208 in an analysis summary area 222, which is displayed above the upper most bands 216-218 used in the analysis. The results are displayed in the form of a chart 226-232 and are rendered by the computer 100 in an animation.

At this point the user 134 may again decide, in step 3.10, if any further partitioning of the data is desired, if so the user 134 continues on to step 3.12 to perform the desired partitioning, otherwise, the user 134 continues to step 3.20 where again the user 134 may decide to perform analysis on any of the populated bands 216-218, if so the user 134 proceeds to step 3.22 to repeat the analysis steps, otherwise the user 134 completes the analysis stage and moves on to the final stage 3.30.

In step 3.32 the user 134 may optionally export some or all of the charts generated during the analysis stage 3.08, to a desired file format, examples of possible file formats include a standalone discrete image file such as an SVG file, a JPG file, a PNG file, a GIF file or a BMP file, or an HTML file. In step 3.34 the user 134 may optionally save some or all methods used during the analysis stage 3.08, such as analysis steps and or a description of the structure of the data table 206, the primary band 216 and the secondary bands 218, including record 210 ordering criteria of the data table 206, record selection criteria of the primary band 216 and the secondary bands 218, and chart display types of the primary band 216 and the secondary bands 218. Any saved methods may be applied at a later time to another database 126. And in step 3.36 the user 134 goes on to other tasks.

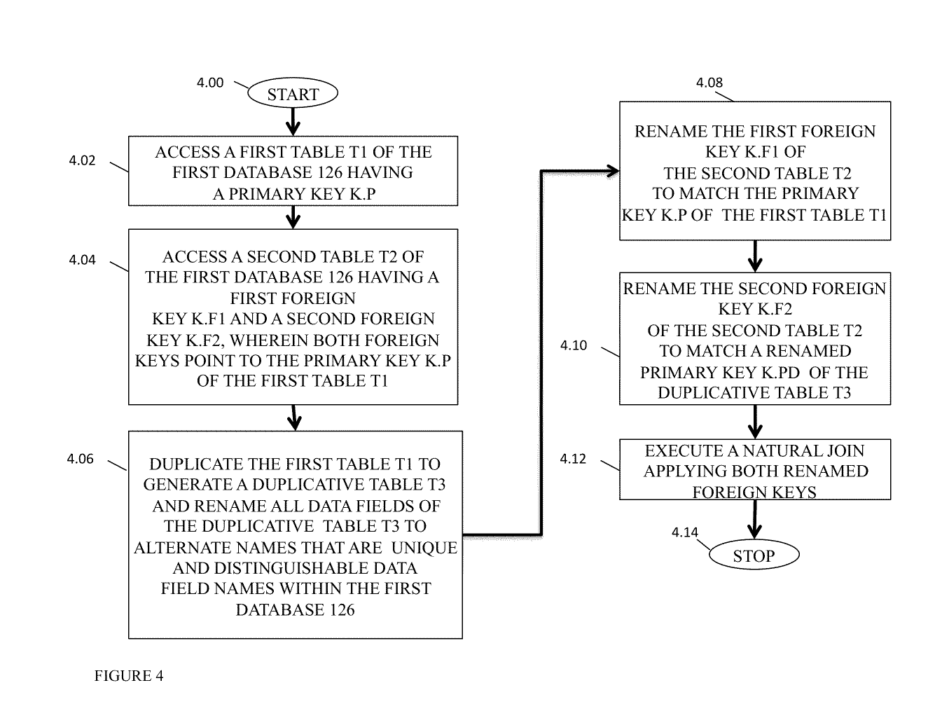

Referring now generally to the Figures and particularly to FIG. 4, FIG. 4 is a flow chart depicting a possible use of invented method to perform a natural join between two tables T1 & T2 of a relational database 126-130. One exemplary use of the optional aspects of the invented method disclosed in FIG. 4, and not mentioned as a limitation of the invented method, is a method to perform a natural join on two or more tables T1-T7 wherein the records of each selected table T1-T7 are filtered by using only records presented in certain bands 216 & 218, e.g. the primary band 216 of FIG. 2, or other user-selected elements of bands, entire contents of one or more selected band 216 & 218, and/or one or more tables T1-T7.

The computer 100 begins in step 4.00, then in step 4.02 the computer 100 accesses a first table T1 of a relational database 126-130 having a primary key K.P, the table T1 contains at least one record 210 and at least one field 208. In step 4.04 the computer 100 accesses a second table T2 of a relational database 126 having two foreign keys K.F1 and K.F2, both of which point to the primary key K.P of the first table T1. In step 4.06 the computer 100 duplicates the first table T1 by generating to a duplicative table T3 and renaming all data fields 208 of the duplicative table T3 to alternate names that are unique and distinguishable data field names within the first database 126 and preferably unique within the computer 100. The generation of the duplicative table T3 includes renaming the first table primary key K.P to an alternatively named duplicative primary key K.PD.

In step 4.08 the computer 100 renames the first foreign key K.F1 to match the primary key K.P of the first table T1. Then, in step 4.10 the computer 100 then renames the second foreign key K.F2 to match the name of the renamed duplicative primary key K.PD of the duplicative table T3. In step 4.12 the computer 100 now executes a natural join by applying both (a.) the renamed first foreign K.F1 of the second table T2 to the first table T1; and (b.) the renamed second foreign K.F2 of the second table T2 to the duplicative first table T3. The computer 100 proceeds on to alternate computational operations in step 4.14.

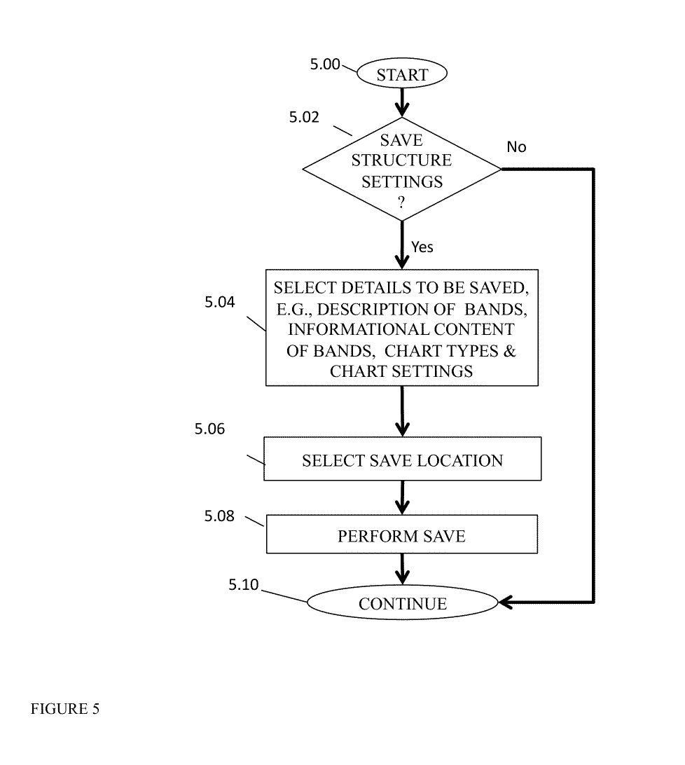

Referring now generally to the Figures and particularly to FIG. 5, FIG. 5 is a flow chart depicting possible steps in saving some or all of the analysis steps and or structure descriptions created by a user 134 in one embodiment of invented method. The user 134 begins in step 5.00 and may optionally save some or all of analysis steps and structure descriptions of the present database 126 for use at a later time in analysis of a different database 126-130, if the user 134 chooses to do so, in step 5.04 the user 134 will select exactly which details are to be saved, possible analysis steps and or descriptions of the structure of the data table 206 include the structure of the primary band 216 and the secondary bands 218, including record 210 ordering criteria of the data table 206, record selection criteria of the primary band 216 and the secondary bands 218, and chart display types of the primary band 216 and the secondary bands 218. Once the desired details have been selected, the user 134 goes on to step 5.06 where a file save location is specified, then in step 5.08 the computer 100 performs the save and stores any necessary files in the user 134 specified save location. After step 5.08 or if no saving was desired in step 5.02 the user 134 continues to perform additional computational tasks in step 5.10.

In various alternate preferred embodiment of the invented method, the selected data in step 5.04 may be saved as an SQL query in step 5.06 that may later be applied by an SQL compliant database management system, e.g., DBMS 124.

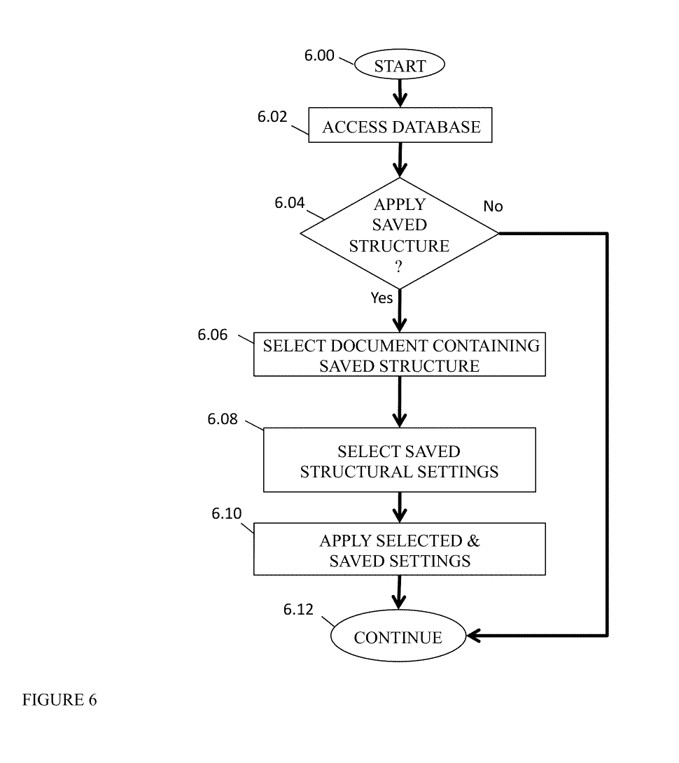

Referring now generally to the Figures and particularly to FIG. 6, FIG. 6 is a flow chart depicting a use of invented method in applying previously saved analysis steps and or a description of the structure of the data table 206, the primary band 216 and the secondary bands 218, including record 210 ordering criteria of the data table 206, record selection criteria of the primary band 216 and the secondary bands 218, and chart display types of the primary band 216 and the secondary bands 218, to a presently open database 126. The user 134 begins at step 6.00, and in step 6.02 the user 134 directs the computer 100 to open one or more databases 126-130 on which analysis is to be performed. In step 6.04 the user 134 decides, and accordingly directs the computer 100, whether or not to apply previously analysis steps or structure description to the presently open database 126, if so the user 134 by interaction with the computer 100 navigates to and selects a previously saved file containing saved information in step 6.06, then in step 6.08 the user 134 by interaction with the computer 100 selects which details contained in the file should be applied to the present database 126. Once all desired selections have been made the computer 100 applies all possible selected steps and structure descriptions to the present database 126 in step 6.10. Afterward, or if the user 134 chooses not to apply previously saved descriptions in step 6.04, computer 100 responds to user direction and proceeds on to perform additional computational tasks in step 6.12.

A saved SQL query in step 6.08 may alternatively later be applied by an SQL compliant database management system.

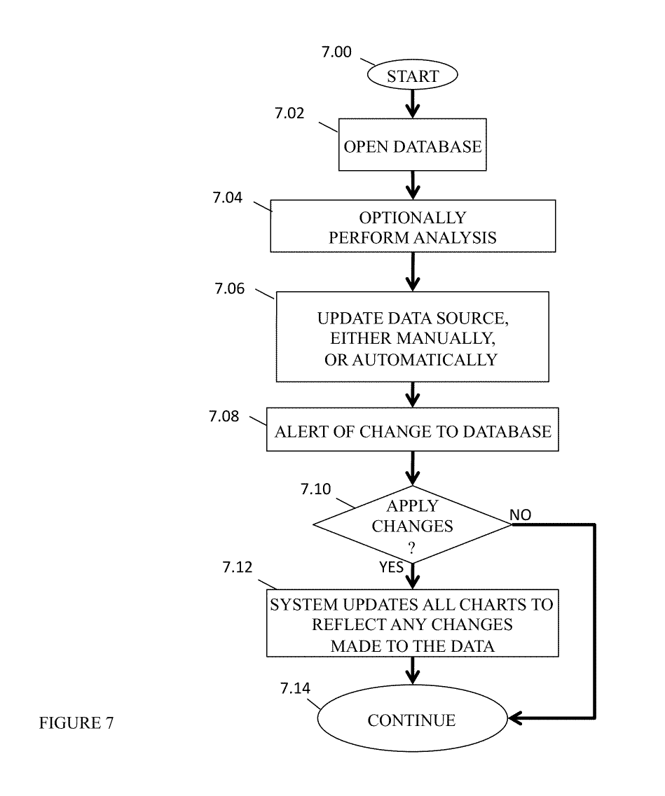

Referring now generally to the Figures and particularly to FIG. 7, FIG. 7 is a flow chart depicting a use of invented method where the data source used for analysis is updated either by the user 134 or automatically by the computer 100 and all charts are updated by the computer 100 to reflect all changes made to the data source. The user 134 begins in step 7.00 and by interaction with the computer 100 accesses a database 126 in step 7.02, in step 7.04 the user 134 by direction of and interaction with the computer 100 may optionally perform additional analysis on the first database 126 and optionally additional databases 128-130, then in step 7.06 either the user 134 by interaction with the computer 100 updates the database 126 directly, or the computer 100 automatically updates the database 126 as a result of an action trigger such as new data becoming available, or updates being made to the database 126. The computer 100, in step 7.08, alerts the user 134 that a change has been made to the database 126, and in step 7.10 the user 134 may, by direction and input to the computer 100, choose whether or not any changes should be reflected in the analysis presently being performed. If the user 134 chooses to have the changes applied, the computer 100, in step 7.12 updates all affected display elements, including tables 206, charts 226-232 in any of the bands 216-218 and charts 226-232 in any analysis summary bands 222. The computer 100 proceeds on to perform additional computational tasks in step 7.14.

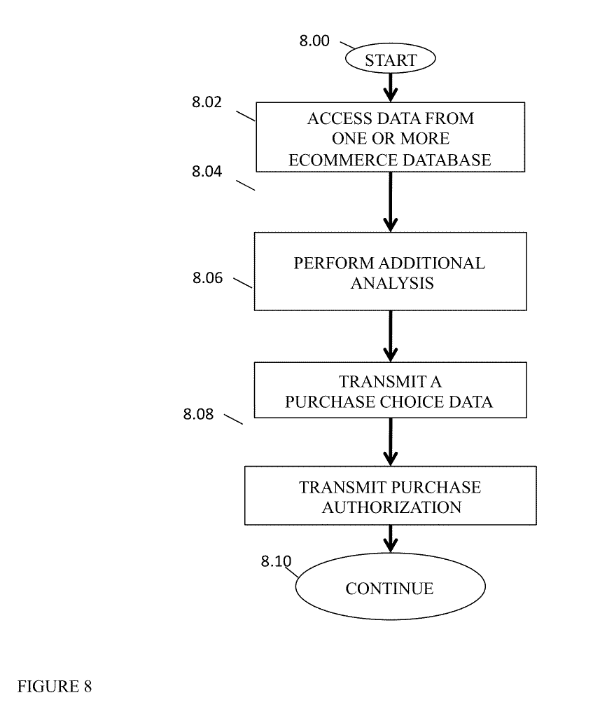

Referring now generally to the Figures and particularly to FIG. 8, FIG. 8 is a flow chart depicting a use of invented method to access and analyze data from one or more ecommerce data sources, and transmit both a purchase choice and purchase authorization. The user 134 begins in step 8.00, and in step 8.02 the user 134 by interaction with the computer 100 accesses data from one or more ecommerce databases 126-130 containing at least two records 210, examples of such data may include products, product descriptions, product prices, service prices, service options, and any other information that may be considered when making a purchase decision. In step 8.04 the user 134 may optionally perform analysis by means of data partitioning and analysis in accordance with invented method. Upon completing analysis the user 134 may, by interaction with the computer 100, transmit a purchase choice in step 8.06, and a purchase authorization in step 8.08. And in step 8.10 the computer 100 proceeds on to perform additional computational tasks.

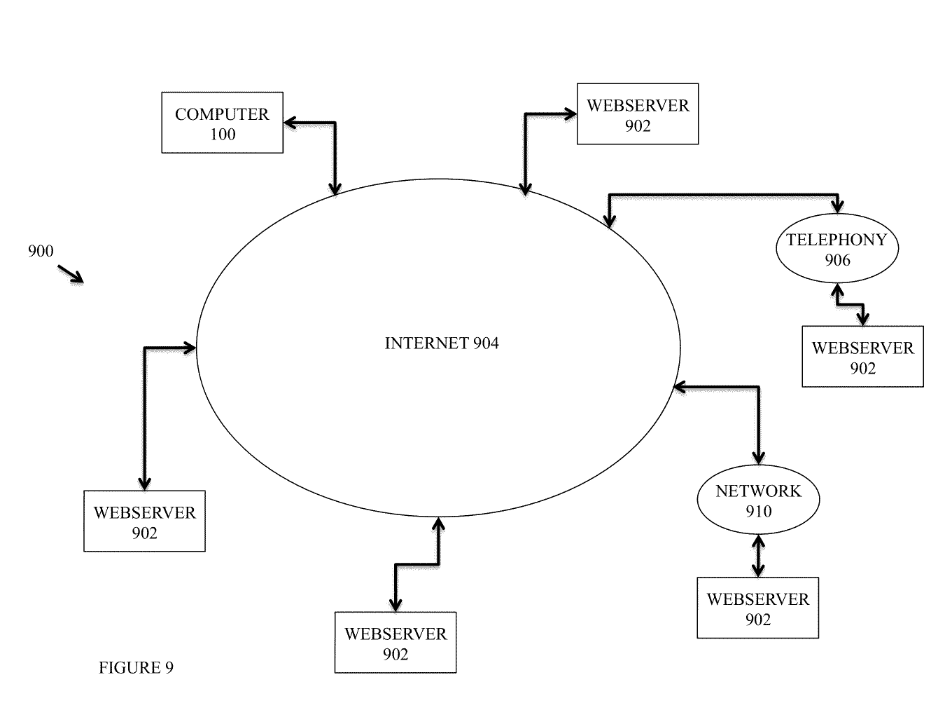

Referring now generally to the Figures and particularly to FIG. 9, FIG. 9 is a network diagram illustrating the computer 100 in bi-directional communicative coupling with an electronics communications network 100 that includes a plurality ecommerce webservers 902. The electronics communications network 900 may include the Internet 904, one or more telephony networks 906, and/or one or more computer communications networks 910. Each ecommerce webservers 902 hosts and makes available a unique ecommerce website that is bi-directionally communicatively with the computer 100 via network interface 132. It is understood that each unique ecommerce website is compliant with the bi-directional communications protocols of the World Wide Web.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible configurations or aspects of the present invention. The examples given should only be interpreted as illustrations of some of the preferred configurations or aspects of the present invention, and the full scope of the present invention should be determined by the appended claims and their legal equivalents. Those skilled in the art will appreciate that various adaptations and modifications of the just-described preferred embodiments could be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

I claim:

1. A computer-implemented method for visualizing a partitioning of a table of data (“data table”), the method comprising:
accessing a plurality of records, each record comprising a set of values, the records and sets of values organized as data fields of the data table;
rendering a primary band, the primary band comprising at least one chart, the at least one chart graphically representing a plurality of values of at least one data field;
accepting a user command to selectively access at least one record of the at least one chart; and
rendering the data values of the at least one record in a secondary band, whereby the at least one record is partitioned from the primary band and the at least one record remains visually represented in the secondary band.

2. The method of claim 1, further comprising rendering the data table within an additional band, wherein the rendering of data values within the primary band and the secondary band are visually aligned with the data fields of the data table.

3. The method of claim 2, wherein the rendering of data values within the secondary band is visually aligned with the data fields of the data table and the charts of the primary band.

4. The method of claim 1, wherein at least one chart comprises a bar chart.

5. The method of claim 4, wherein the bar chart is organized in ascending values.

6. The method of claim 4, wherein the bar chart is organized in descending values.

7. The method of claim 1, wherein at least one chart of the primary band represents values of at least two data fields.

8. The method of claim 7, wherein the at least one chart is a scatter chart.

9. The method of claim 7, wherein the at least one chart is a line chart.

10. The method of claim 7, wherein the at least one chart is a pie chart.

11. The method of claim 1, further comprising saving a description of the structure of the data table, the primary band and the secondary band, including record ordering criteria of the data table, record selection criteria of the primary band and the secondary band, and chart display types of the primary band and the secondary band.

12. The method of claim 11, further comprising applying the saved description of the structure of the data table, the primary band and the secondary band to a rendering of a second plurality of records.

13. The method of claim 1, wherein at least two records are sourced from a first ecommerce data base.

14. The method of claim 13, wherein at least one alternate record is sourced from a second ecommerce data base.

15. The method of claim 13, further comprising transmitting an item purchase indication in association with a record.

16. The method of claim 15, further comprising transmitting a purchase authorization.

17. The method of claim 1, further comprising adjusting a selection of a rendered data range within at least one chart as directed by a user command input entered into a dialogue box

18. The method of claim 1, wherein a population of at least one chart of the at least one band is rendered as an animation.

19. The method of claim 1, wherein the transition of the at least one record from the primary band to the secondary band is rendered as an animation.

20. The method of claim 1, wherein the data table and the charts are automatically updated with newly accessed records.

21. The method of claim 1, further comprising exporting a single selected chart as a discrete image.

22. A computer-implemented method of performing a join operation in a relational database (“the database”), the method comprising:
accessing a first table having a primary key;
accessing a second table having a first foreign key and a second foreign key, wherein both foreign keys point to the primary key of the first table;
duplicating the first table generated to a duplicated table and renaming all data fields of the duplicated table to alternate names that are unique and distinguishable data field names within the database;
renaming the first foreign key to match the primary key of the first table;
renaming the second foreign key to match a renamed primary key of the duplicated first table; and
executing a natural join applying the first foreign key to primary key of the first table and the second foreign key to the renamed primary key of the duplicated first table.
